(19) United States
(12) Patent Application Publication
(10) Pub. No.: US 2019/0120188 A1
(43) Pub. Date: Apr. 25, 2019

(54) FUEL INJECTOR

(71) Applicant: DELPHI TECHNOLOGIES IP LIMITED, St. Michael (BB)

(72) Inventors: Thierry Thibault, Saint-Ouen-les-Vignes (FR); Christophe Moreau, La Chaussée Saint-Victor (FR)

(21) Appl. No.: 16/090,389

(22) PCT Filed: Mar. 22, 2017
(86) PCT No.: PCT/EP2017/056890

§ 371 Date: Oct. 1, 2018

(30) Foreign Application Priority Data
Apr. 1, 2016 (FR) 1652872
Apr. 7, 2016 (FR) 1653083

(51) Int. Cl. F02M 47/02; F02M 51/00; F02M 61/12; F02M 65/00; F02M 51/06

(52) U.S. Cl. CPC F02M 47/027; F02M 51/005; F02M 2200/245; F02M 65/005; F02M 51/0657; F02M 61/12

(57) ABSTRACT

A fuel injector includes an injection nozzle with a body, in which a needle moves between a closed position, in which a first end of the needle rests on a seat, and an open position, in which the first end of the needle is lifted from the seat. The fuel injector also includes a control chamber, a control valve, and an upper guide guiding the needle axially by the second end thereof. An electric link in contact with the second end of the needle bring the needle to a predetermined electric potential. The needle is mounted in the body so as to be able to move therein while being electrically isolated from the body, except for the region of the seat, so that the needle is in electric contact with the body only in the closed position.

### CROSS REFERENCE TO RELATED APPLICATIONS

This application is a national stage application under 35 USC 371 of PCT Application No. PCT/EP2017/056890 having an international filing date of Mar. 22, 2017, which is designated in the United States and which claimed the benefit of FR Patent Application Nos. 1652872 and 1653083 filed on Apr. 1, 2016, and Apr. 7, 2016, respectively, the entire disclosures of each are hereby incorporated by reference in their entirety.

### TECHNICAL FIELD

The present invention generally relates to the field of fuel injectors and, more specifically, to an injector provided with a means for detecting the position of the needle.

### PRIOR ART

A fuel injector conventionally comprises a needle that is controlled to open and close as a function of the pressure prevailing in a control chamber, which pressure is a function of the position of a control solenoid valve. These small movements occur at high speed and steadily increasing performance levels now require feedback with respect to the actual position of the needle in order to provide optimum control.

Devices are known in which a sensor is arranged on the injector or even an injector is known in which some surfaces of the components of the body are provided with resistive coatings, so that an electric resistance measurement can be performed between two elements of the injector.

For example, document FR 3013080 can be cited in which the injector comprises resistive surface coatings arranged on a plurality of contact surfaces between parts and in which the overall electric resistance of the injector between the body of the solenoid actuator and the injector body varies by at least three distinct ohmic values by intermittence according to the kinetics of the injection needle of the injector.

These complex and expensive devices have not yet proven their industrial practicality. One problem in the proposed systems is associated with the complexity and with the number of resistive surface coatings on a plurality of contact surfaces between the parts of the injector.

### Subject Matter of the Invention

The subject matter of the present invention is to propose a fuel injector allowing the position of the needle to be detected in a simple, reliable and inexpensive manner.

### General Description of the Invention

The present invention relates to a fuel injector for an internal combustion engine, comprising:
an injection nozzle with a body, in which a needle is arranged that can be moved between a closed position (CP), in which a first end of the needle rests on a seat and seals injection openings of the nozzle, and an open position (OP), in which the first end of the needle is lifted from the seat thereof in order to allow the injection;
a control chamber filled, during operation, with fuel so as to exert pressure on the second end of the needle;
a control valve associated with the control chamber allowing the fuel pressure in the control chamber to be selectively varied and thus control an opening or closing movement of the needle, the control valve being driven by an actuator; and
an upper guide guiding the needle axially by the second end thereof.

According to the invention, a means for detecting the position of the needle comprises a first electric link in contact with the second end of the needle so as to bring said needle to a predetermined electric potential. The needle is mounted in the nozzle body so as to be able to move therein while being electrically isolated from the nozzle body, except for the region of the nozzle body seat, so that the needle is in electric contact with the nozzle body only in the closed position.

In the invention, the needle thus acts as a switch that allows or prevents the passage of current from the needle head (second end) to the nozzle body, which is generally connected to ground (or is set to a determined potential, different from the potential of the first electric link). The only needle position that allows passage of detection current is the closed position CP. The injector is designed so that, as soon as the needle lifts, the current no longer passes from the needle to the nozzle body (either directly or indirectly).

As will be explained hereafter, the significant advantage of the injector according to the invention is its simplicity combined with efficiency. It only requires a minor modification of the design of the injector, while allowing access to the fundamental data, namely the moment of opening and closing of the injector needle, essential for managing injection in the engine.

The upper guide preferably is an added element comprising a bore for guiding the needle and is installed at the inlet of the nozzle body. The upper guide forms the terminal part of the first electric link, which allows the needle to be brought to the desired potential; it is assembled with the nozzle body so as to be electrically isolated therefrom.

According to one embodiment, the nozzle body, the upper guide element, the valve and the actuator are superposed inside an injector body extending along the axis of the needle, the nozzle body being in electric contact with the injector body, whereas the upper guide, the valve and the actuator are in mutual electric contact, but are isolated from the injector body.

In particular, the control valve body and the actuator body are electrically isolated at their periphery relative to the injector body. This electric isolation can be provided by any suitable means, by placing a coating around the control valve body and the actuator body when they are manufactured, by producing a coating inside the injector body, at suitable locations, or even by adding insulation when assembling the injector.

In general, the needle is guided to at least one location of the nozzle body between the upper guide and the seat. The surfaces of the nozzle body in contact with the needle, called guiding surfaces, are advantageously provided with an electric insulating coating.

Alternatively, the needle surfaces that come into contact with the guiding surfaces of the nozzle body can be insulated.

Advantageously, the first electric link extends from the upper guide to an external electric connection means to facilitate the electric connection of this end of the circuit. The nozzle can be connected simply by screwing a support part connected to ground (or to another potential). The first electric link can be completed by an insulated wire extending from the external electric connection means to the upper guide. Alternatively, the first electric link is completed by an insulated wire extending from the external electric connection means to the actuator body, and the electric link continues through electric contact with the valve body and the upper guide. The first electric link even can be completed by an insulated wire extending from the external electric connection means to the valve body, with the electric link continuing through electric contact with the upper guide.

Thus, the detection circuit defines an electric path passing through the first electric link with the upper guide and the needle in order to pass, via the seat, to the nozzle body.

Preferably, the nozzle seat is coated with a resistive layer having a predetermined resistance, which allows the resistance of the seat contact to be calibrated.

It is worth noting that even though the present invention has been developed within the scope of a diesel injector, it is fully interchangeable with an injector for petrol or for any other fuel.

### DETAILED DESCRIPTION WITH REFERENCE TO THE FIGURES

Further specific features and characteristics of the invention will become apparent from the detailed description of at least one advantageous embodiment provided hereafter by way of an illustration, with reference to the accompanying drawings, in which:

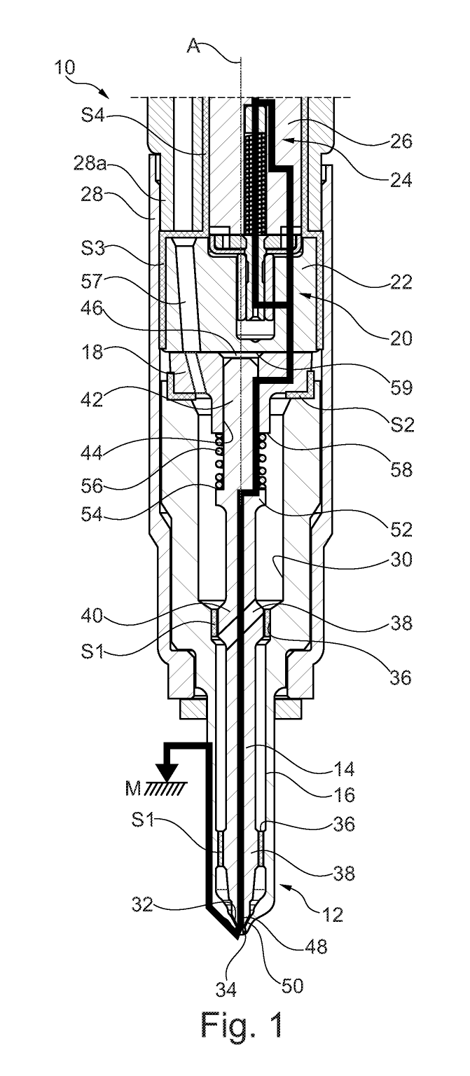

FIG. 1 is an axial section view of a first embodiment of the present injector, with the needle being in the closed position;

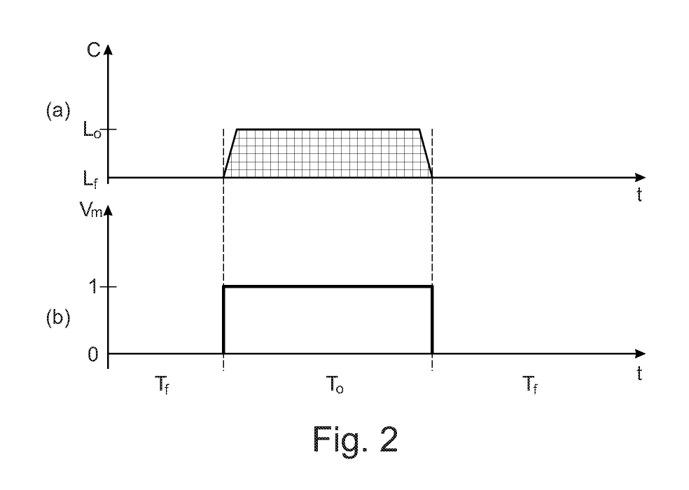

FIG. 2 shows two graphs illustrating (a) the stroke of the needle and (b) the voltage measured as a function of time; and

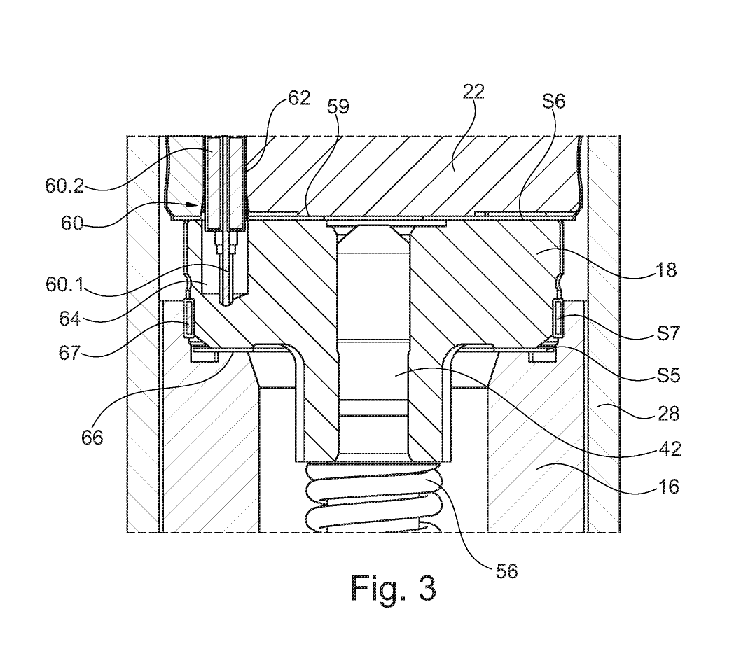

FIG. 3 is a detailed section view showing the isolation of the upper guide, according to another embodiment.

FIG. 1 shows an embodiment of the invention relating to a fuel injector 10, in this case a diesel injector, even though the invention is fully interchangeable with an injector for petrol or for any other fuel, the injector 10 generally forming part of an injection system comprising a plurality of injectors. The description will describe the elements of the invention and will remain more succinct and general with respect to the surrounding elements.

The injector 10 extends along a main axis A and comprises, from bottom to top, according to the conventional and non-limiting direction of the figures: a nozzle 12 comprising a needle 14 arranged in a nozzle body 16, an upper guide element 18, a control valve 20 comprising a valve body 22, in which a fuel passage is arranged with a seat and a sealing component, an actuator 24 comprising an actuator body 26 accommodating a fixed coil and a movable magnetic armature. The control valve 20 and the actuator 24 can be of the conventional type and therefore are not described in detail. The nozzle body 16, the upper guide 18, the valve body 22 and the actuator body 26 are rigidly held together by any suitable means. Conventionally, an injector body 28 can be used in the form of a nut coming into abutment on a shoulder of the nozzle body 16 and being screwed on the actuator body 26, with the valve body 22 being sandwiched between the other two bodies. It is also possible to have an upper part, as is the case herein, a distinct injector body part, called injector support body 28a, accommodating the control valve and the actuator, on which the injector body 28 is screwed. The injector body therefore is formed by the parts 28 and 28a.

The nozzle body 16 comprises an internal stepped axial bore 30, extending from an upper end, where it has a wide diameter, to a lower end closing to a point, so as to form a tapered nozzle body seat 32 allowing control of fuel access to the injection openings 34 extending through the tapered wall of the nozzle body 16. In the lower part, the bore 30 forms, at two locations, a lower cylindrical guide 36, in the vicinity of which the needle 14 comprises a projecting annular section 38 sliding in the lower guide 36. Fuel passage in the vicinity of this lower guide occurs, for example, through one or more calibrated opening(s) or neck(s) (straight or helical) in the annular projection 38.

The guidance of the upper part of the needle 14 is provided by the upper guide 18, which is an independent part arranged between the nozzle body 16 and the valve body 22 and is fixedly held by the assembly of the injector parts, particularly by the axial compression exerted by the injector nut. The upper guide 18 guides the upper portion of the needle 14, called needle head 42, through a guide bore 44. The needle head 42, in combination with the valve body 22 and the guide bore 44, define a control chamber 46.

The terms “upper” and “lower” are used herein not only with reference to the orientation of the figure, but also with reference to the common name assigned to these elements by professionals.

The needle 14 is generally cylindrical and extends axially A between the needle head 42, at the top of the figure, and a pointed end 48, at the bottom of the figure, forming a needle seat 50 cooperating with the nozzle body seat 32 of the body 16.

When the needle rests on the nozzle body seat 32, it is in the closed position CP, fuel injection via the openings 34 is prevented. The needle 14 is lifted by adjusting the pressure in the control chamber 46, which allows the needle to be brought to a fully open position, denoted OP (typically in upper abutment), in which the fuel can pass toward the injection openings 34.

As can be seen, the lower guide 36 is near the needle seats 50 and the nozzle body 32.

The needle 14 is provided with an annular protuberance 52, the upper face 54 of which, directed toward the needle head 42, provides a support surface for a spring 56 urging the needle 14 toward the closed position CP thereof, in which the needle tip 48 rests on the seat 32 thereof and seals the injection openings 34. The spring 56 is arranged under the upper guide 18 and it is compressed against the lower surface 58 of the upper guide.

The injector 10 also is conventionally provided with a fuel circulation circuit, which, on the one hand, allows the high-pressure fuel to be fed via a high-pressure circuit 57, from an inlet opening to the injection openings 34 and, on the other hand, allows fuel to be recirculated toward a low-pressure tank via an internal low-pressure circuit (not shown). The high-pressure circuit particularly comprises a by-pass channel (not shown) leading to the control chamber 46, where the low-pressure circuit leaves via a discharge channel (not shown), the opening and closing of which is controlled by the control valve. When the coil of the actuator is supplied with power, it attracts the magnetic armature connected to the sealing component of the control valve, which opens the discharge channel and allows the fuel contained in the control chamber 46 to be discharged toward the low-pressure circuit. The pressure in the control chamber 46 then lowers, and the needle 14 moves in the bore of the nozzle body to a fully open position OP, in which the needle seat 50 is separated from the valve body seat 32, so as to allow fuel to be injected via the injection openings 34, the top of the needle head 42 being in contact with the ceiling surface 59 (formed by the lower surface of the valve body 22) of the control chamber 46.

When the actuator is not supplied with power, the magnetic armature and valve sealing component assembly is pushed by a valve spring to a position in which the discharge channel is closed, which retains the incoming high-pressure fuel in the control chamber 46. The pressure in the control chamber 46 then rises and the needle 14, pushed by the spring 56 and by the pressure in the control chamber 46, moves to the closed position CP, in which the needle seat 50 is in sealed contact between the nozzle body seat 32, so as to prevent fuel injection, and in which the top of the needle head 42 is separated from the ceiling surface 59 of the control chamber 46. This operation is well known.

In order to precisely determine the moment of opening and of closing of the needle 14, the injector is provided with a means for detecting the position of the needle 14.

It is to be understood that the means for detecting the position of the needle 14 comprises an electric detection circuit with a switch function, for which the needle 14 forms the movable contactor.

In the embodiment provided, the detection circuit allows an electric measurement EM to be performed between an electric connection means outside the injector and the ground M (or more generally a different potential), to which the nozzle body 16 and the injector body 28 are connected.

Firstly, it will be noted that the needle is mounted in the nozzle body 16 so as to be able to move therein, while being electrically isolated from the nozzle body 16, except for the region of the nozzle body seat 32, respectively the needle seat 50. This requires the use of electric insulating material since most of the parts of the injector, particularly the nozzle body, the needle, the upper guide, the valve body, the actuator body and the injector body are made of metal (steel), and thus conduct electricity.

To this end, the contact surfaces between the needle 14 and the nozzle body 16 are insulated, for example, by means of an electric insulating coating, denoted S1, applied on the guiding surfaces of the nozzle body. Alternatively, insulating coatings can be applied on the needle 14, in the vicinity of the contact zones with the needle body 16. However, the nozzle body seat 32, the needle seat 50, the needle head 42 and the guide bore 44 remain electric conductors and are devoid of an electric insulating coating. Advantageously, the needle seat 50 comprises a resistive layer (not shown) having a predetermined resistance, which allows the contact resistance value to be calibrated (i.e., when the needle rests on the seat).

An electric insulating layer S2 is also provided between the upper guide 18 and the nozzle body 16, in order to electrically isolate the upper guide from the nozzle body. Since, in the variation provided, the upper face of the upper guide 18 is in contact with the valve body 22, more insulating layers S3 and S4 are provided on the periphery of the valve body 22 and of the actuator body 26, which is also in contact with the valve body 22.

The detection circuit for its part comprises a first electric link in contact with the upper part 42 of the needle 14, so as to bring it to a predetermined electric potential. This first link in this case is produced to connect the upper guide 18 to an external electric connector (not shown). As the upper part 42 of the needle 14 is guided by, and in electric contact with, the upper guide 18, said upper guide forms the terminal part of the first electric link.

In FIG. 1, the first electric link is completed by means of an insulated electric wire (not shown) extending from the external electric connector to the actuator body 26, and the electric link continues through electric contact with the valve body 22 and the upper guide 18.

Alternatively, an insulated electric wire can be drawn from the external electric connector to the valve body 22 or to the upper guide 18 (see the variation in FIG. 3). This electric wire can pass through the respective bodies or to their periphery.

The arrangement of the parts of the injector in combination with the electric coatings S1 to S4 therefore allows a detection circuit to be defined in which the needle is the only movable component and acts as a contactor element allowing the detection circuit to be closed or opened, i.e., to connect or not connect the first electric link to ground, depending on whether the needle is in the closed or open position.

When the needle 14 is in the closed position CP, as is the case in FIG. 1, the detection circuit is closed. An electric detection current that is applied in the vicinity of the external connector can circulate through the actuator body 26 and the valve body 22 up to the upper guide 18, then pass through the needle head 42 to the needle tip 48. As the needle 14 is in the closed position CP, the needle seat 50 is in contact with the body seat 32. Since this seat region is not electrically isolated, the current can flow from the needle 14 to the nozzle body 16, and therefore to ground. This electric path is indicated by the thick black line in FIG. 1.

As will be understood, as soon as the needle 14 lifts during activation with a view to an injection, the electric contact of the needle seat is interrupted and the detection circuit opens.

In this case, it is to be noted that the nozzle body does not need to be connected to ground, it also can be set to a given potential. In general, a potential difference is desired between the first electric link and the nozzle body, in order to be able to detect the contact of the needle.

The detection circuit remains open as long as the needle 14 is lifted, whether it is in the ballistic or fully open position. Indeed, the upper guide 18 and the valve body 22 are in electric contact and at the same potential as the needle. There is no other needle position that is likely to close the detection circuit to ground. The moment at which the needle reaches its fully open position OP, in abutment against the valve body in the control chamber, is not detected.

Thus, the “closed” state of the detection circuit corresponds to the only closed position CP of the needle 14, when it rests on the body seat 32. The detection circuit is in the “open” state as long as the needle 14 is partially or fully lifted.

As will be understood by a person skilled in the art, the open/closed transition of the detection circuit will allow the two key moments of the activation of the injector to be identified, namely the opening and closing thereof.

For the purposes of the detection, a measurement unit is configured to measure the potential difference Vm between the ground of the vehicle and the external connector of the first link, to which a given voltage is applied.

FIG. 2 uses two superposed graphs to show the stroke C of the needle 14 and the voltage Vm as a function of time. In the closed position CP, the needle rests on the seat thereof and the detection circuit is closed, allowing current to pass to ground, which is expressed by a zero voltage Vm (shown as level “0” on the graph). As soon as the needle leaves its seat, the contact is interrupted and the measured voltage is that which is applied to the external connector, which is shown as level “1” on the graph.

The period during which the needle is in the closed position CP (zero stroke Lf) is denoted Tf. The needle is open during the period TO, during which it reaches the fully open position LO.

The transition Vm=0 to Vm=1 therefore indicates the moment at which the needle leaves its seat, and therefore the beginning of opening of the needle. The transition Vm=1 to Vm=0 indicates the moment at which the needle returns to its seat, and therefore the closing of the needle.

It will be understood that the present injector allows reliable detection of the opening and closing of the injector without significant modification of the design.

The insulating layers S1 to S4 can be produced using any techniques and from any suitable materials. The thickness of the coatings can be up to 100 μm, for example. They can be deposited as a layer on the relevant surfaces, for example, using vacuum deposition techniques or even can be produced as separate parts that are installed during assembly.

FIG. 3 relates to another variation, in which the first electric link is completed by means of an insulated electric wire 60 extending from the external electric connector to the upper guide 18. This electric wire can pass through the respective bodies or to their periphery. More generally, the insulated electric wire is arranged in the upper part of the injector, from the external connector to the upper guide.

As can be seen in FIG. 3, the electric wire 60 comprises a metal conductor wire 60.1 surrounded by an electric insulating coating 60.2. The wire is guided from the external connector through the upper part of the injector, and passes through a passage 62 arranged in the valve body 22 in order to reach a housing 64 of the upper guide. In the housing 64 of the upper guide 18, the end of the wire 60 is bare, so as to establish electric contact between the external electric connector and the upper guide 18, allowing the needle 14 to be brought to the desired potential through contact with the end 42 thereof.

As in the variation of FIG. 1, the upper guide is compressed between the nozzle body 16 and the valve body 22. However, in the present variation, the upper guide 18 is electrically isolated from the nozzle body 16, as well as from the valve body 22.

To this end, in the embodiment of FIG. 3, two parts, denoted S5 and S6, made of electric insulating material are installed under the lower and upper face of the upper guide 18. The part S5, which is generally in the form of a washer, therefore is located between the lower face of the upper guide 18 and the inner shoulder 66 of the part of the nozzle body 16 that allows the upper guide to be centred and axially blocked.

The upper insulating part S6 is located at the interface between the upper face of the upper guide 18 and the lower face 59 (glass face) of the valve body 22, in order to mutually electrically isolate them. This part S6 can assume the form of a disk made of electric insulating material, comprising suitable perforations, particularly for the passage of the wire 60 and the passage of fuel, in particular from the control chamber 46 to the control valve body 22. However, the part S6 also provides the electric isolation of the needle head 42 with respect to the valve body 22. The presence of an electric insulation S7 is also to be noted that surrounds part of the peripheral wall of the upper guide, at the interface with the cylindrical wall 67 of the nozzle body 16 bordering the shoulder 66. This electric insulating layer S7 preferably is produced by a process that is intended to form an insulating layer deposit on the part.

This variation is worthwhile in terms of the assembly of the injector. With the insulating coating S7 being produced on the upper guide 18, the insulating parts S5 and S6 simply need to be positioned, when manufacturing the injector, to electrically isolate the upper guide 18 from the neighboring parts.

1-10. (canceled)

11. A fuel injector for an internal combustion engine, comprising:
an injection nozzle with a nozzle body, in which a needle is arranged that can be moved between a closed position, in which a first end of the needle rests on a seat and seals injection openings of the injection nozzle, and an open position, in which the first end of the needle is lifted from the seat thereof in order to allow injection;
a control chamber filled, during operation, with fuel so as to exert pressure on the second end of the needle;
a control valve associated with the control chamber allowing fuel pressure in the control chamber to be selectively varied and thus control opening and closing movement of the needle, the control valve being driven by an actuator;
an upper guide guiding the needle axially along an axis of the needle by the second end thereof; and
means for detecting position of the needle;
wherein the means for detecting position of the needle comprise a first electric link in contact with the second end of the needle so as to bring the needle to a predetermined electric potential; and
wherein the needle is mounted in the nozzle body so as to be able to move therein while being electrically isolated from the nozzle body, except for the seat, so that the needle is in electric contact with the nozzle body only in the closed position.

12. The fuel injector as claimed in claim 11, wherein the upper guide is an added element installed at an inlet of the nozzle body and electrically isolated therefrom, the upper guide forming a terminal part of the first electric link.

13. The fuel injector as claimed in claim 12, wherein:
the nozzle body, the upper guide, the control valve, and the actuator are superposed inside an injector body extending along the axis of the needle, the nozzle body being in electric contact with the injector body; and
the upper guide, the control valve, and the actuator are in mutual electric contact, but are isolated from the injector body.

14. The injector as claimed in claim 13, wherein a control valve body of the control valve and an actuator body of the actuator are electrically isolated at their periphery relative to the injector body.

15. The fuel injector as claimed in claim 11, wherein the first electric link extends from the upper guide to an external electric link means.

16. The fuel injector as claimed in claim 15, wherein the first electric link is completed by an insulated conductor wire extending from the external electric link means to the upper guide, the upper guide being compressed between the nozzle body and a control valve body of the control valve and electrically isolated therefrom.

17. The fuel injector as claimed in claim 15, wherein the first electric link is completed by an insulated conductor wire extending from the external electric link means to an actuator body of the actuator, and the first electric link continues through electric contact with a control valve body of the control valve and the upper guide; or
the first electric link is completed by an insulated conductor wire extending from the external electric connection means to the control valve body of the control valve, the electric link continuing through electric contact with the upper guide.

18. The fuel injector as claimed in claim 11, wherein the nozzle body comprises surfaces for guiding the needle between the upper guide and the seat, the guiding surfaces being provided with an electric insulating coating.

19. The fuel injector as claimed in claim 11, wherein the means for detecting position of the needle defines an electric path passing through the first electric link with the upper guide and the needle in order to pass, via the seat, to the nozzle body.

20. The fuel injector as claimed in claim 11, wherein the seat is coated with a resistive layer having a predetermined resistance.
